(19) United States
(12) Patent Application Publication
(10) Pub. No.: US 2016/0162302 A1
(43) Pub. Date: Jun. 9, 2016

(54) FAST INITIATION OF WORKLOADS USING MEMORY-RESIDENT POST-BOOT SNAPSHOTS

(71) Applicant: Strato Scale Ltd., Herzlia (IL)

(72) Inventors: Eduardo Warszawski, Kfar Saba (IL); Muli Ben-Yehuda, Haifa (IL)

(21) Appl. No.: 14/930,674

(22) Filed: Nov. 3, 2015

Related U.S. Application Data
(60) Provisional application No. 62/088,611, filed on Dec. 7, 2014.

(51) Int. Cl. G06F 9/44; G06F 9/445

(52) U.S. Cl. CPC G06F 9/4406; G06F 9/44505

(57) ABSTRACT

A method includes, in a computing system including one or more compute nodes that run workloads, booting a workload of a given type, and creating a post-boot snapshot of the workload at a point at which the workload completed booting but did not yet begin running user applications. In response to a request to initiate a new workload of the given type, the new workload is initiated starting from the post-boot snapshot.

### CROSS-REFERENCE TO RELATED APPLICATIONS

This application claims the benefit of U.S. Provisional Patent Application No. 62/088,611, filed Dec. 7, 2014, whose disclosure is incorporated herein by reference.

### FIELD OF THE INVENTION

The present invention relates generally to computing systems, and particularly to methods and systems for managing Virtual Machines (VMs) and other workloads.

### BACKGROUND OF THE INVENTION

Machine virtualization is commonly used in various computing environments, such as in data centers and cloud computing. Various virtualization solutions are known in the art. For example, VMware, Inc. (Palo Alto, Calif.), offers virtualization software for environments such as data centers, cloud computing, personal desktop and mobile computing.

### SUMMARY OF THE INVENTION

An embodiment of the present invention that is described herein provides a method including, in a computing system including one or more compute nodes that run workloads, booting a workload of a given type, and creating a post-boot snapshot of the workload at a point at which the workload completed booting but did not yet begin running user applications. In response to a request to initiate a new workload of the given type, the new workload is initiated starting from the post-boot snapshot.

In some embodiments, creating the post-boot snapshot includes storing the post-boot snapshot in volatile memory, and initiating the new workload includes fetching the post-boot snapshot from the volatile memory. In an embodiment, creating the post-boot snapshot is performed in response to a first request to initiate a workload of the given type. In a disclosed embodiment, creating the post-boot snapshot includes initiating a given workload from a workload image, identifying the point in which the given workload completes booting but does not yet begin running user applications, and acquiring the post-boot snapshot at the identified point.

In some embodiments, the new workload is to be assigned one or more workload-specific attribute values, and initiating the new workload includes cloning the post-boot snapshot, and modifying one or more attributes in the cloned post-boot snapshot to the workload-specific attribute values. In an example embodiment, the workload-specific attribute values include at least one of a hostname and an Internet Protocol (IP) address. In another example embodiment, modifying the attributes includes directly modifying one or more memory locations in the cloned post-boot snapshot in which the attributes are stored.

There is additionally provided, in accordance with an embodiment of the present invention, an apparatus including an interface and a processor. The interface is configured for communicating with a computing system including one or more compute nodes that run workloads. The processor is configured to boot a workload of a given type, to create a post-boot snapshot of the workload at a point at which the workload completed booting but did not yet begin running user applications, and, in response to a request to initiate a new workload of the given type, to initiate the new workload starting from the post-boot snapshot.

There is also provided, in accordance with an embodiment of the present invention, a computer software product, the product including a tangible non-transitory computer-readable medium in which program instructions are stored, which instructions, when read by a processor that is coupled to a computing system including one or more compute nodes that run workloads, cause the processor to boot a workload of a given type, to create a post-boot snapshot of the workload at a point at which the workload completed booting but did not yet begin running user applications, and, in response to a request to initiate a new workload of the given type, to initiate the new workload starting from the post-boot snapshot.

There is further provided, in accordance with an embodiment of the present invention, a computing system including one or more compute nodes configured to run workloads, and a management system. The management system is configured to boot a workload of a given type, to create a post-boot snapshot of the workload at a point at which the workload completed booting but did not yet begin running user applications, and, in response to a request from one of the compute nodes to initiate a new workload of the given type, to initiate the new workload starting from the post-boot snapshot.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system, in accordance with an embodiment of the present invention; and

FIG. 2 is a flow chart that schematically illustrates a method for Virtual Machine (VM) creation and initialization, in accordance with an embodiment of the present invention.

### DETAILED DESCRIPTION OF EMBODIMENTS

### Overview

Embodiments of the present invention that are described herein provide improved methods and systems for running Virtual Machines (VMs) and other types of workloads. In some embodiments, a computing system comprises one or more compute nodes configured to run VMs of one or more types. VM types may differ from one another, for example, in the user applications they run, e.g., a Web server as opposed to a database server, and/or in the characteristics of the physical machines they emulate, e.g., in configuration or Operating System (OS).

Typically, the system stores a respective VM image for each VM type. The VM image may comprise, for example, the content of the VM's virtual disk, including the OS and OS-version, one or more user applications, and other relevant information. When a compute node requests to create a new VM of a certain type, the system may retrieve the VM image of that type from storage, install a copy of the VM image on the requesting compute node, and start the VM. The VM will start by booting and then launching the appropriate applications.

In many practical implementations, the VM images are stored on non-volatile storage devices such as magnetic or solid-state disks. The process of starting a new VM may therefore incur considerable latency.

In some embodiments of the present invention, the system shortens the process of starting a new VM by holding post-boot snapshots of the different VM types in volatile memory. In the present context, the term “post-boot snapshot of a VM” refers to a snapshot of a VM that is taken at a point (in time or in the VM execution sequence) in which the VM completed booting but did not yet begin running user applications. Typically although not necessarily, the system creates the post-boot snapshot for a given VM type upon the first time such a VM is requested.

In an embodiment, the system uses the post-boot snapshots as templates for starting new VMs. When a compute node requests to create a new VM of a certain type, the system checks whether a post-boot snapshot is available for this VM type. If available, the system clones a copy of the post-boot snapshot on the requesting compute node, and starts running the VM from the post-boot stage. Starting a new VM from a clone of a post-boot snapshot typically involves some personalization, e.g., assigning the new VM a hostname and an IP address.

Assuming a post-boot snapshot is available, the disclosed techniques reduce the latency of creating a new VM considerably. Firstly, since the post-boot snapshot is stored in volatile memory rather than in non-volatile storage, its retrieval is fast. Secondly, starting a new VM from the post-boot stage eliminates the latency of the boot process.

### SYSTEM DESCRIPTION

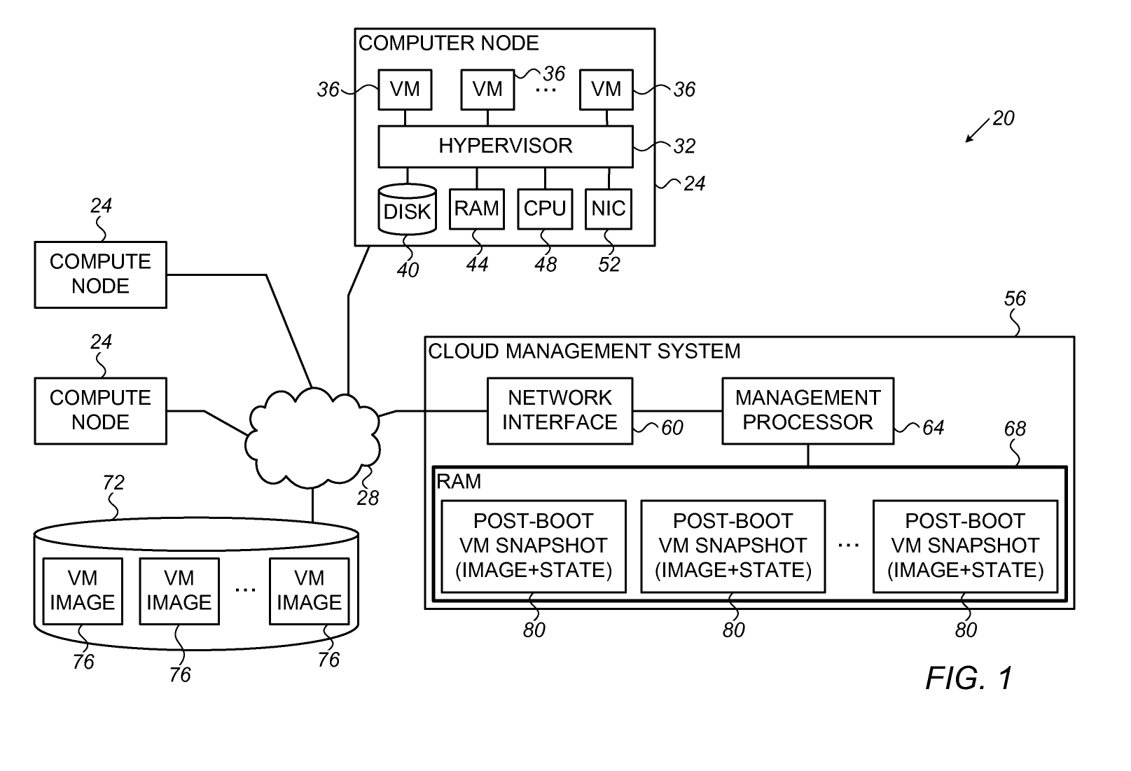

FIG. 1 is a block diagram that schematically illustrates a computing system 20, in accordance with an embodiment of the present invention. In the present example, system 20 comprises a cloud computing system. Alternatively, however, system 20 may comprise a data center, a High-Performance Computing (HPC) system, or any other suitable computing system.

System 20 comprises multiple compute nodes 24 that are connected by a communication network 28. Compute nodes 24 (referred to simply as “nodes” for brevity) typically comprise servers, but may alternatively comprise any other suitable type of compute nodes. System 20 may comprise any suitable number of nodes, either of the same type or of different types. Nodes 24 are also referred to as physical machines. Communication network typically comprises a Local Area Network (LAN). Network 28 may operate in accordance with any suitable network protocol, such as Ethernet or Infiniband.

Each node 24 comprises a physical Central Processing Unit (CPU) 48, a physical memory 44 (typically a volatile Random Access Memory—RAM), and a physical Network Interface Card (NIC) 52 for communicating with network 28. Some of nodes 24 (but not necessarily all nodes) may comprise one or more physical non-volatile storage devices 40 (e.g., magnetic Hard Disk Drives—HDDs—or Solid State Drives—SSDs).

Each node 24 comprises a hypervisor 32 for hosting one or more Virtual Machines (VMs) 36. The hypervisor is typically implemented as a software layer that runs on CPU 48 and allocates physical resources of the node (e.g., resources of CPU 48, memory 44, storage 40 and/or NIC 52) to the various VMs 36. FIG. 1 depicts the internal node structure for only one of compute nodes 24, for the sake of clarity. Typically, all nodes 24 have similar structure.

VMs 36 running on nodes 24 may be of various types. VM types may differ from one another, for example, in the user applications they run, e.g., a Web server as opposed to a database server, and/or in the characteristics of the physical machines they emulate, e.g., in configuration or Operating System (OS). In one illustrative example, one VM type may comprise a Windows-7 VM running an IIS web server, another VM type may comprise a Windows-10 VM running an MS SQL database, yet another VM type may comprise a Redhat Linux VM running an Apache web server, while another VM type may comprise an Ubuntu Linux VM running a PostgresSQL database.

System 20 further comprises a cloud management system 56. Among other tasks, management system 56 initializes and starts new VMs in response to requests from nodes 24, using methods that are described in detail below. In the present example, management system 56 comprises a physical network interface (e.g., NIC) 60 for communicating over network 28, and a physical management processor 64 that carries out the methods described herein.

In some embodiments, cloud management system 56 may be implemented as a standalone system that is separate from nodes 24. In other embodiments, the functionality of cloud management system 56 may be embodied in one or more of nodes 24. In the latter embodiments, the functions of management processor 64 are carried out by one or more CPUs 48 of one or more nodes 24, and the functions of network interface 60 are carried out by one or more NICs 52 of one or more nodes 24.

In some embodiments, system 20 comprises a non-volatile storage 72, in which management system 56 stores VM images 76, one VM image per each VM type. Non-volatile storage 72 may comprise one or more dedicated storage devices (e.g., HDDs or SSDs) as shown in the figure. Alternatively, the functionality of storage 72 may be implemented using the existing storage devices 40 of the nodes. In other words, management system 56 may store VM images 76 on one or more of storage devices 40 of nodes 24. Further alternatively, storage 72 may be internal to management system 56.

A VM image 76 of a certain type of VM may comprise, for example, the content of the virtual disk of the VM of that type. The virtual disk content may comprise, for example, the OS used by that type of VM, one or more user applications running on that type of VM, and/or any other suitable information.

In addition, in some embodiments management system 56 maintains post-boot snapshots 80 for one or more of the VM types. Each post-boot snapshot 80 comprises a snapshot of a VM of a certain type, which is taken at a point (in time or in the VM execution) in which the VM completed booting but did not yet begin running user applications. Methods for producing and using post-boot snapshots are described further below.

In the present example, management system 56 stores post-boot snapshots 80 in a volatile memory (e.g., RAM) 68 of system 56. Alternatively, the post-boot snapshots may be stored on any other suitable volatile memory, e.g., on some dedicated RAM external to system 56, or on RAM 44 of one or more nodes 24.

The system and compute-node configurations shown in FIG. 1 are example configurations that are chosen purely for the sake of conceptual clarity. In alternative embodiments, any other suitable system and/or node configuration can be used. For example, although the embodiments described herein refer mainly to VMs, the disclosed techniques can be used with any other suitable types of workloads, such as applications and/or operating-system processes or containers. Although the embodiments described herein refer mainly to virtualized data centers, the disclosed techniques can be used for communication between workloads in any other suitable type of computing system.

The various elements of system 20, including the elements of nodes 24 and management system 56, may be implemented using hardware/firmware, such as in one or more Application-Specific Integrated Circuit (ASICs) or Field-Programmable Gate Array (FPGAs). Alternatively, some system or node elements may be implemented in software or using a combination of hardware/firmware and software elements.

Typically, processor 64, network interface 60, RAM 68, CPUs 48, memories 44, storage devices 40 and NICs 52 are physical, hardware implemented components, and are therefore also referred to as physical CPUs, physical memories, physical storage devices physical disks, and physical NICs.

In some embodiments, CPUs 32 and/or processor 64 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### EFFICIENT INITIALIZATION OF VIRTUAL MACHINES USING POST-BOOT SNAPSHOTS STORED IN RAM

When a compute code 24 requests to create a new VM 36, it is highly advantageous to respond to this request with small latency. In some embodiments of the present invention, processor 64 of management system 56 shortens the process of creating a new VM, by starting the VM from a post-boot snapshot stored in RAM whenever possible.

In the context of the present disclosure and in the claims, the term “post-boot snapshot of a VM” refers to a snapshot of a VM that is taken at a point (in time or in the VM execution sequence) in which the VM completed booting but did not yet begin running user applications. Processor 64 typically derives post-boot snapshot 80, for a certain type of VM, from VM image 76 of that VM type. Typically although not necessarily, a post-boot snapshot is created upon the first time that a VM of this type is requested. Alternatively, processor 64 may create a post-boot snapshot in advance, independently of any specific request from a compute node, so that even the first request can be served with small latency.

Processor 64 typically creates a post-boot snapshot by starting a VM instance from the appropriate VM image 76, and recognizing the point in which the VM completed its boot process but did not yet start running user applications. At this point, processor 64 takes a snapshot of the VM and stores the snapshot as post-boot snapshot 80 in RAM 68.

“Taking a post-boot snapshot of a VM” typically means that processor 64 stores the image and state of the VM at the point that is estimated to be the end of the boot process. The post-boot snapshot typically comprises a set of memory pages in RAM 44, which contain the complete data and metadata that enable resuming running the VM from the post-boot stage. The snapshot may comprise, for example, the memory pages containing the contents of the VM's virtual CPU registers, the contents of the VM's virtual disk or disks, the contents of the VM's virtual RAM, and the state of the VM's guest OS.

Processor 64 may identify the correct point for taking the post-boot snapshot in various ways. In some embodiments, processor 64 may identify the end of the VM boot process by monitoring the pattern with which the VM retrieves storage blocks from disk. The boot process is typically characterized by a highly predictable pattern of block readout operations that may be recognized, for example, by training some machine-learning algorithm. Some such techniques can be implemented without having to modify the VM itself.

Example techniques for identifying whether a VM completed booting are described by Parush et al., in “Out-of-Band Detection of Boot-Sequence Termination Events,” IBM Research Report H-0268 (H0809-002), Aug. 31, 2008, which is incorporated herein by reference. Alternatively, processor 64 may select the point for taking the post-boot snapshot using any other suitable method.

Typically, when a compute node requests to create a new VM 36 of a certain type, processor 64 checks whether a post-boot snapshot 80 is available for this VM type. If available, processor 64 clones a copy of the post-boot snapshot on the requesting compute node, and starts running the VM from the post-boot stage. In some embodiments, upon receiving a request to create a new VM, processor 64 translates the request into a “clone snapshot” operation.

When a new VM is started from a clone of a post-boot snapshot, some VM attributes in the snapshot should be modified to VM-specific values with which the specific new VM should run. This process is referred to as “personalization.” For example, when the post-boot snapshot is initially created, the booting VM used for creating the snapshot is typically assigned a hostname and an Internet Protocol (IP) address. The values of these attributes, however, change from one VM instance to another. Thus, when creating a new VM from the post-boot snapshot, the new VM should be assigned the appropriate correct hostname and IP address, which are different from those existing in the post-boot snapshot.

After cloning the post-boot snapshot, processor 64 may personalize the attributes of a new VM to their desired VM-specific values in various ways. In an embodiment, processor 64 identifies the memory locations, in the image of the cloned snapshot, in which the attributes are stored. Processor 64 then accesses these memory locations directly and modifies the attributes.

In one embodiment, processor 64 may learn the memory location of a given attribute in the VM image offline, e.g., by booting multiple VM instances and finding memory locations that change from one instance to another. Alternatively, processor 64 may search the memory pages of the post-boot snapshot, and identify all the memory locations in the image that contain a given assigned attribute value. For example, processor 64 may search the memory pages of the post-boot snapshot for all occurrences of the IP address assigned to the VM used for creating the post-boot snapshot.

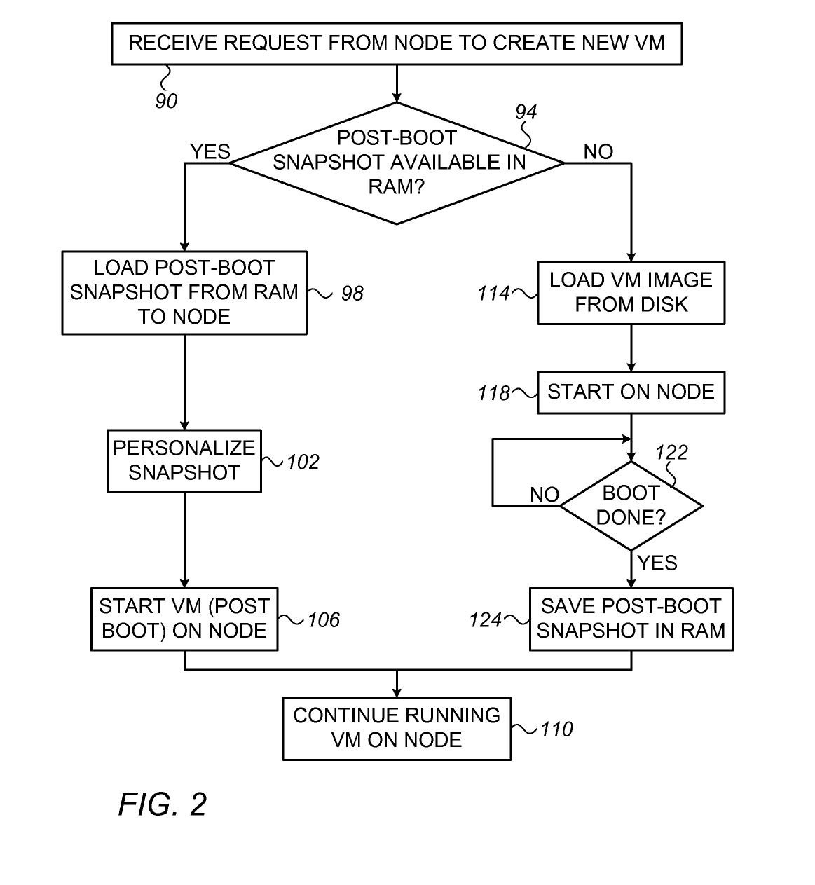

FIG. 2 is a flow chart that schematically illustrates a method for VM creation and initialization, in accordance with an embodiment of the present invention. The method is carried out by management processor 64 of cloud management system 56. The method begins with processor 64 receiving, via interface 60, a request from a certain compute node 24 to create a new VM of a given type, at a requesting step 90. The compute node is referred to below as a “requesting node” for brevity.

At a snapshot availability checking step 94, processor 64 checks whether a post-boot snapshot 80 is available for the given type of VM. If available, processor 64 begins a process of starting the new VM from the post-boot snapshot.

Processor 64 loads the post-boot snapshot from RAM 68 and installs a copy of the post-boot snapshot on the requesting node, at a copying step 98. At a personalization step 102, processor 64 modifies one or more attributes of the post-boot snapshot installed on the requesting node to the appropriate values needed for the requested VM. Processor 64 starts running the new VM from the personalized post-boot snapshot, at a post-boot start-up step 106. The hypervisor of the requesting node then runs the new VM, at a running step 110.

If, on the other hand, no post-boot snapshot is found (at step 94) for the given type of VM, processor 64 begins a process that creates the requested VM from a VM image, and also creates and saved a post-boot snapshot for later use.

At an image loading step 114, processor 64 loads a VM image 76 of the requested type from storage 72. At an image start-up step 118, processor 64 installs the VM image on the requesting node and starts the VM. At a boot termination checking step 122, processor 64 checks whether the VM completed its boot process.

As soon as termination of the boot process is identified, processor 64 takes a snapshot of the VM and store the post-boot snapshot in RAM 68, at a snapshot creation step 124. Subsequent requests for VMs of this type can thus be served using the post-boot snapshot (by following steps 98-106). The method then proceeds to step 110, in which the hypervisor of the requesting node continues to run the new VM.

The method flow of FIG. 2 is an example flow that is depicted purely by way of example. In alternative embodiments, system 20 may carry out the disclosed techniques using any other suitable method flow.

Although the embodiments described herein mainly address fast launching of VM images, the methods and systems described herein can also be used in other applications, such as in fast launching of applications or workload containers.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a computing system comprising one or more compute nodes that run workloads, booting a workload of a given type, and creating a post-boot snapshot of the workload at a point at which the workload completed booting but did not yet begin running user applications; and
in response to a request to initiate a new workload of the given type, initiating the new workload starting from the post-boot snapshot.

2. The method according to claim 1, wherein creating the post-boot snapshot comprises storing the post-boot snapshot in volatile memory, and wherein initiating the new workload comprises fetching the post-boot snapshot from the volatile memory.

3. The method according to claim 1, wherein creating the post-boot snapshot is performed in response to a first request to initiate a workload of the given type.

4. The method according to claim 1, wherein creating the post-boot snapshot comprises initiating a given workload from a workload image, identifying the point in which the given workload completes booting but does not yet begin running user applications, and acquiring the post-boot snapshot at the identified point.

5. The method according to claim 1, wherein the new workload is to be assigned one or more workload-specific attribute values, and wherein initiating the new workload comprises cloning the post-boot snapshot, and modifying one or more attributes in the cloned post-boot snapshot to the workload-specific attribute values.

6. The method according to claim 5, wherein the workload-specific attribute values comprise at least one of a hostname and an Internet Protocol (IP) address.

7. The method according to claim 5, wherein modifying the attributes comprises directly modifying one or more memory locations in the cloned post-boot snapshot in which the attributes are stored.

8. Apparatus, comprising:
an interface for communicating with a computing system comprising one or more compute nodes that run workloads; and
a processor, which is configured to boot a workload of a given type, to create a post-boot snapshot of the workload at a point at which the workload completed booting but did not yet begin running user applications, and, in response to a request to initiate a new workload of the given type, to initiate the new workload starting from the post-boot snapshot.

9. The apparatus according to claim 8, wherein the processor is configured to store the post-boot snapshot in volatile memory, and to initiate the new workload by fetching the post-boot snapshot from the volatile memory.

10. The apparatus according to claim 8, wherein the processor is configured to create the post-boot snapshot in response to a first request to initiate a workload of the given type.

11. The apparatus according to claim 8, wherein the processor is configured to create the post-boot snapshot by initiating a given workload from a workload image, identifying the point in which the given workload completes booting but does not yet begin running user applications, and acquiring the post-boot snapshot at the identified point.

12. The apparatus according to claim 8, wherein the new workload is to be assigned one or more workload-specific attribute values, and wherein the processor is configured to initiate the new workload by cloning the post-boot snapshot, and modifying one or more attributes in the cloned post-boot snapshot to the workload-specific attribute values.

13. The apparatus according to claim 12, wherein the workload-specific attribute values comprise at least one of a hostname and an Internet Protocol (IP) address.

14. The apparatus according to claim 12, wherein the processor is configured to modify the attributes by directly modifying one or more memory locations in the cloned post-boot snapshot in which the attributes are stored.

15. A computer software product, the product comprising a tangible non-transitory computer-readable medium in which program instructions are stored, which instructions, when read by a processor that is coupled to a computing system comprising one or more compute nodes that run workloads, cause the processor to boot a workload of a given type, to create a post-boot snapshot of the workload at a point at which the workload completed booting but did not yet begin running user applications, and, in response to a request to initiate a new workload of the given type, to initiate the new workload starting from the post-boot snapshot.

16. A computing system, comprising:
one or more compute nodes configured to run workloads; and
a management system, which is configured to boot a workload of a given type, to create a post-boot snapshot of the workload at a point at which the workload completed booting but did not yet begin running user applications, and, in response to a request from one of the compute nodes to initiate a new workload of the given type, to initiate the new workload starting from the post-boot snapshot.
